(19) United States
(12) Patent Application Publication
(10) Pub. No.: US 2005/0013559 A1
(43) Pub. Date: Jan. 20, 2005

(54) Interface adaptor

(75) Inventors: Goncalo Agra Amorim, Ipswich (GB); Daniel John Keeble, Felixstowe (GB); Stuart Graham Wilkinson, Manningtree (GB)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/620,737

(22) Filed: Jul. 16, 2003

(51) Int. Cl. G02B 6/42

(52) U.S. Cl. 385/92

(57) ABSTRACT

The present invention provides an interface adaptor for an opto-electronic device, the interface adaptor comprising: a first portion for receiving an optical connector; a second portion for receiving an opto-electronic device; and a third portion for connecting the first portion to the second portion, wherein the second portion comprises a first aperture to receive the opto-electronic device within the second portion of the interface adaptor; and a second aperture to receive the opto-electronic device, the first and second apertures comprising one or more projections located at the periphery of the apertures.

### FIELD OF THE INVENTION

This invention relates to interface adaptors, and in particular to interface adaptors for use with opto-electronic devices.

### BACKGROUND OF THE INVENTION

Optical communications systems are conventionally used to provide data and telecommunications at high data rates and over long distances. Optical fibre has many advantages over other communication bearers, for example the huge bandwidth, low attenuation, RFI immunity, etc. One of the disadvantages of certain types of optical fibre is that the light that carries the transmitted data is confined within a very small area, as the typical diameter of the core of an optical fibre is less than 10 μm. Clearly, it is important that great precision is used when connecting two optical fibres together to form a communications link in order to reduce any losses associated with the connection.

If optical fibres are to be joined together permanently then conventionally a splicing machine will be used and typically such machines are able to join single mode fibres such that the loss caused by the connection is around 0.05 dB. When it is desired to connect two fibres together such that the connection can be broken and then re-made it is conventional to use a mechanical connector. The optical loss of one of these connectors is much greater than that of an optical splice, and the loss may also be quite variable.

### SUMMARY OF THE INVENTION

According to a first aspect of the invention there is provided an interface adaptor for an opto-electronic device, the interface adaptor comprising: a first portion for receiving an optical connector; a second portion for receiving an opto-electronic device; and a third portion for connecting said first portion to said second portion, wherein the second portion comprises (a) a first aperture to receive said opto-electronic device within said second portion of said interface adaptor; and (b) a second aperture to receive said opto-electronic device, said first and second apertures comprising one or more projections located at the periphery of said apertures.

Said second portion may further comprise one or more retaining means to resist the removal of an opto-electronic device from said interface adaptor.

Said first and second apertures of said second portion may comprise three or more projections located at the periphery of said apertures.

Said second portion may further comprise engagement means such that an opto-electronic device can be secured relative to said interface adaptor by engaging an opto-electronic device and said engagement means with a securing device. Said interface adaptor may be formed from a plastics material or a malleable metal. One or more plastic regions of said interface adaptor may be coated with a metallic material or with a film that may be electrically conductive or insulative.

### BRIEF DESCRIPTION OF THE DRAWINGS

FIG. 1 shows a schematic depiction of an interface adaptor according to the present invention;

FIGS. 2 to 5 show a schematic depiction of an interface adaptor according to the present invention from a first perspective view;

FIG. 6 shows a schematic depiction of an interface adaptor according to the present invention from a second perspective view;

FIG. 7 shows a schematic depiction of an interface adaptor according to the present invention from an end view; and

FIG. 8 shows a schematic depiction of a circuit board incorporating an interface adaptor according to the present invention.

The following description of the preferred embodiment is not intended to limit the invention to these embodiments, but rather to enable any person skilled in the art of packaging opto-electronic components to make and use this invention.

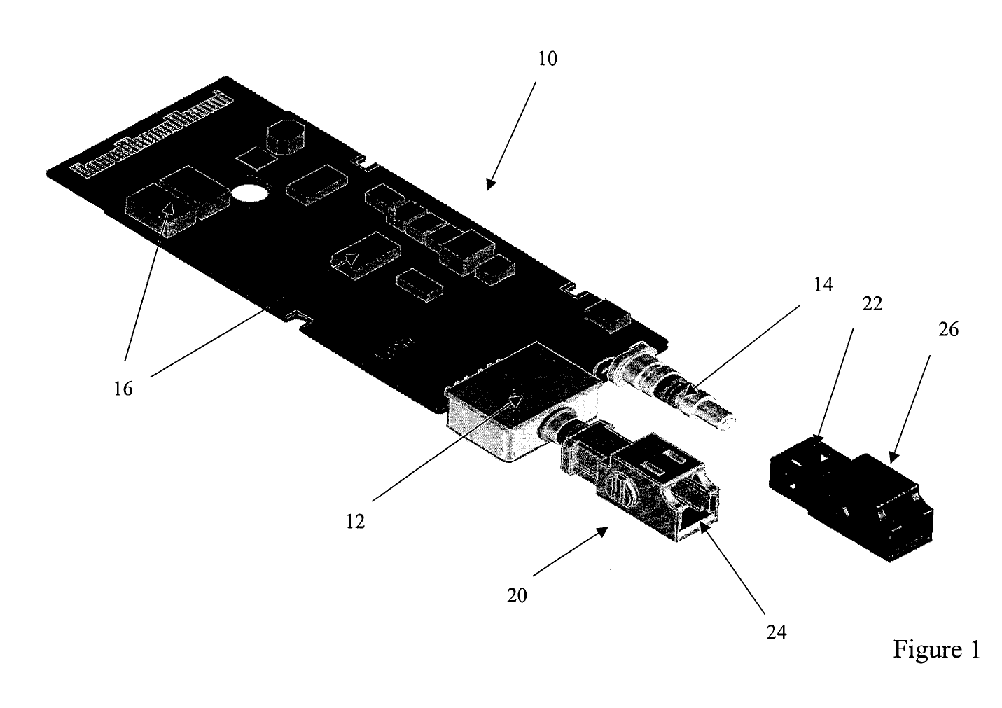

FIG. 1 shows a schematic depiction of the present invention. Circuit board 10 comprises optical transmitter 12 and optical receiver 14, and printed circuits and components 16. The optical transmitter 12 allows modulated light to be transmitted into an optical fibre for onward transmission to a receiver at a remote location and optical receiver 14 enables the detection of modulated light that has been transmitted by a second optical transmitter that is remotely located. The circuits 16 control the signals sent to the optical transmitter 12 for transmission and the electrical signals generated by the optical receiver 14. The circuits 16 may perform the modulation and/or demodulation of the transmitter and receiver signals respectively, or they may route the signals to other equipment (not shown) that perform the modulation and/or demodulation. It is conventional for the optical transmitter 12 and the optical receiver 14 to be connected to optical fibres that have been terminated with an optical connector. An interface adaptor 20 according to the present invention comprises a body region 26, a device interface 22 and a connector interface 24. The device interface 22 engages with an opto-electronic device, such as an optical transmitter or an optical receiver, and the connector interface 24 is designed to receive an optical connector. As there are a number of different proprietary connectors the connector interface will be designed to be compatible with one of these connector designs.

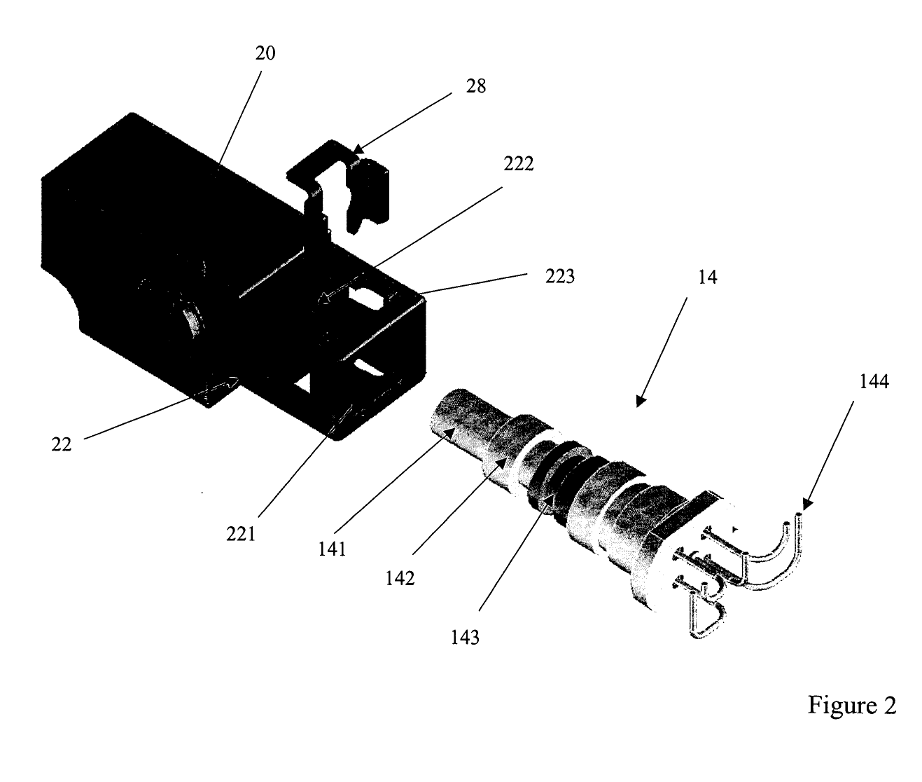

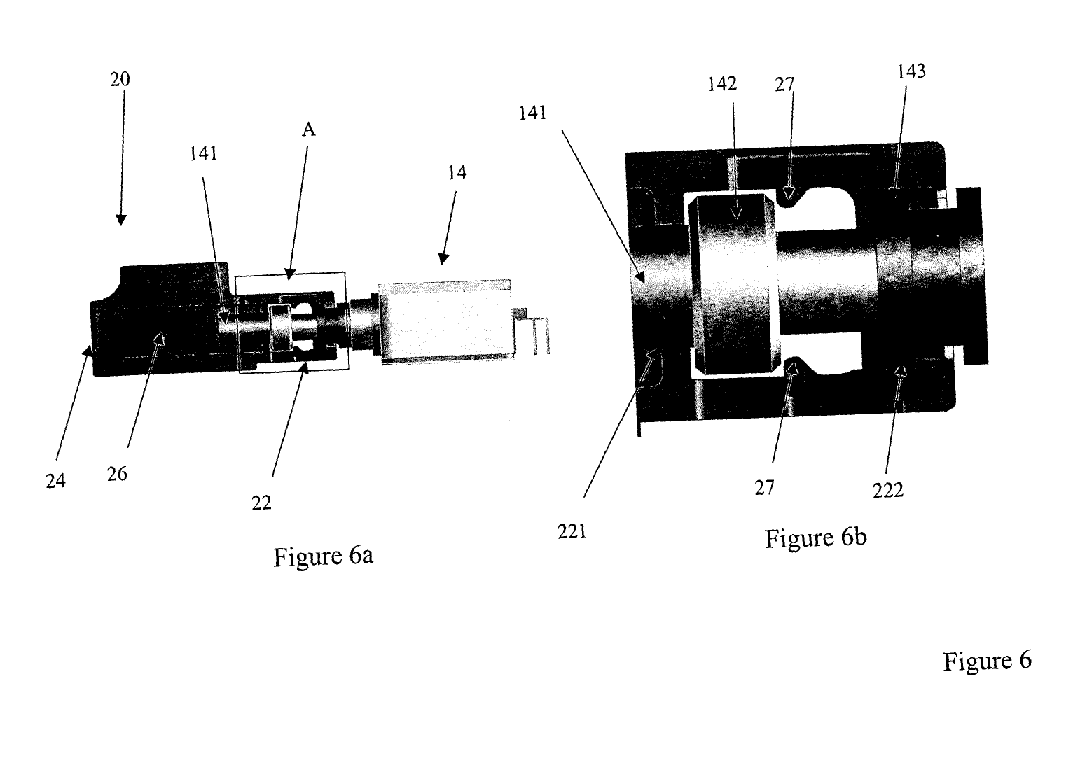

FIGS. 2 to 6 show a schematic depiction of an interface adaptor according to the present invention, with FIGS. 2-5 showing the interface adaptor in isometric views (top and bottom) and FIG. 6 showing the interface adaptor from one side.

FIG. 2 shows a schematic depiction of an interface adaptor 20 according to the present invention, with the device interface 22 comprising an external aperture 221, an internal aperture 222 and securing means 223. Device 14 is shown in greater detail and comprises first device alignment means 141, retention means 142, second device alignment means 143 and electrical contacts 144.

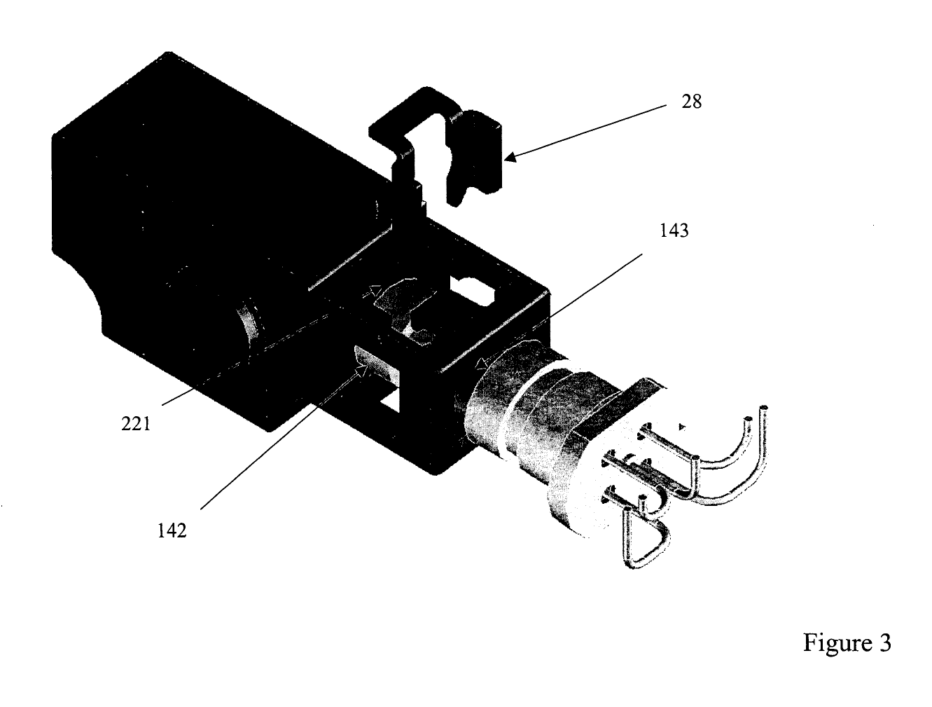

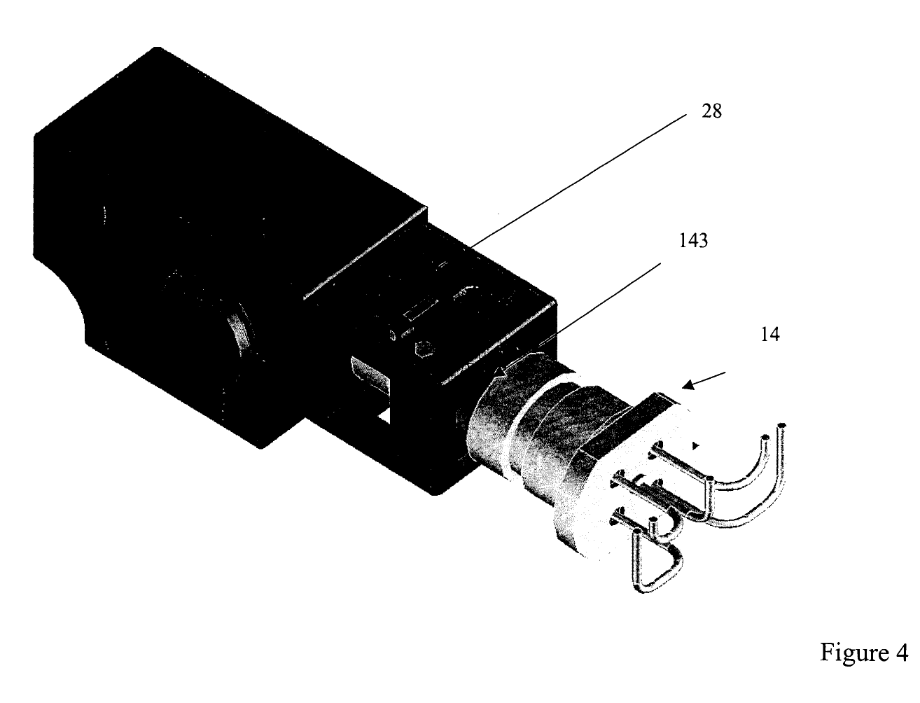

As can be seen from FIGS. 3 and 4, when the device 14 is inserted into the interface adaptor 20 the cylindrical region 141 passes through the external aperture and is received within the internal aperture, such that the cylindrical region of the device is held within the body region 26 of the interface adaptor. The retention means 142 is brought into contact with the exterior of the interface adaptor, limiting the further movement of the device into the interface adaptor. The second device alignment means 143 is located relative to the securing means 223 such that mating the clip 28 against the securing means 223 can be used to secure the device 14 relative to the interface adaptor 20 (see FIG. 3).

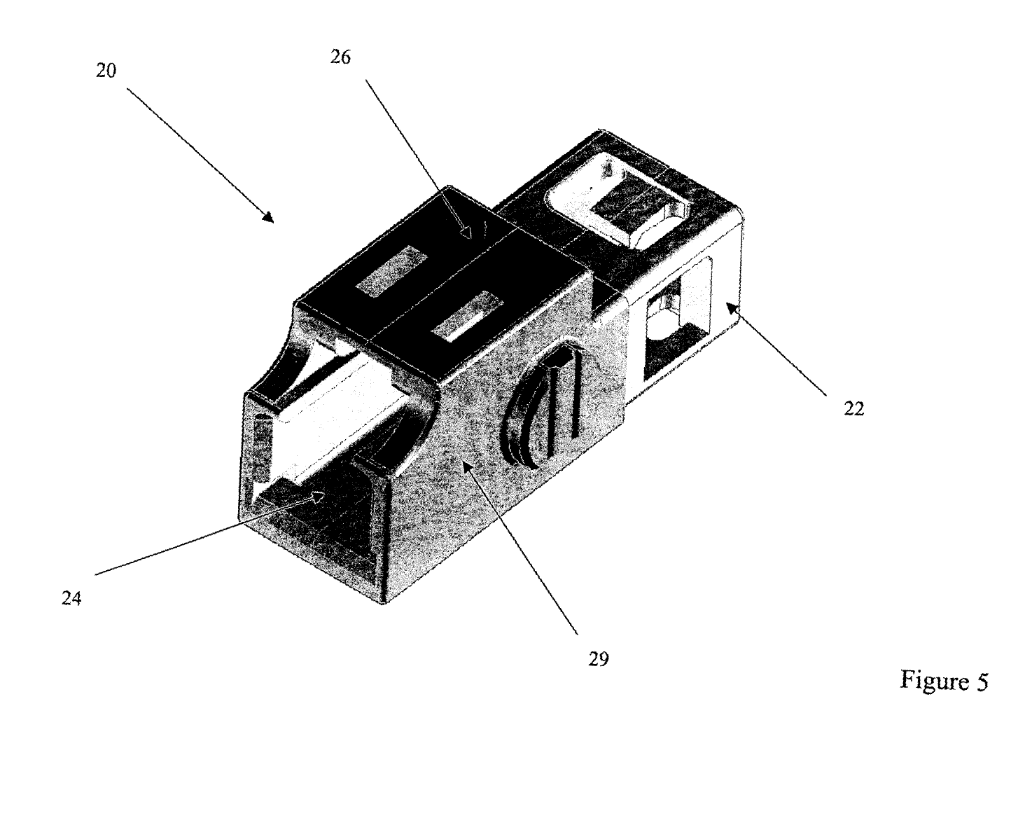

FIG. 5 shows a schematic depiction of an embodiment of the present invention, in which the connector interface 24 and the body region 26 have been selectively coated, in order to reduce the level of electromagnetic emissions from the interface adaptor.

FIG. 6a shows a schematic depiction of a further embodiment of the present invention, with the device 14 being shown in a partial cross-sectional view, with FIG. 6b showing a more detailed view of the part of FIG. 6a that is indicated by box A. In order to hold the opto-electronic device in a concentric position such that it will be in optical alignment with a connector that is inserted into the connector interface locating means are provided around the periphery of the external aperture 221 and the internal aperture 222. These locating means may be a continuous ridge, or a plurality of discrete features (not shown). In order to ensure that the opto-electronic device is correctly aligned, it is preferred to use three or more discrete locating means. Additionally, the interface adaptor may further comprise retaining means 27, which allow first device alignment means 142 to pass through as the opto-electronic device is inserted into the interface adaptor, yet resist the removal of the opto-electronic device from the interface adaptor.

Known techniques for providing an interface between an opto-electronic device and an optical connector are more complex than the interface adaptor of the present invention. Typically, the opto-electronic device would be actively aligned with an assembly comprising the female component of an optical connector and the assembly would be fixed to the device, typically through spot-welding. One advantage of the present invention is that the opto-electronic device may be simply pushed into the interface adaptor and the device retained through a snap-fit connection (and optionally further secured using the clip 28), with the geometry of the interface adaptor causing the connector and the device to be in optical communication. The adaptor of the present invention greatly reduces the complexity and the time taken to couple an opto-electronic device to an optical connector. It will be understood that there are a range of different optical connectors that may be used (typically a network operator will specify which design of connector is to be used) and the present invention enables the simple removal of an interface adaptor in order for it to be replaced with an interface adaptor that can be used with an optical connector of a different design. This is a significant advantage to equipment manufacturers as it will reduce manufacturing costs, inventory overhead and increase flexibility through the use of modular equipment.

With conventional techniques it is also extremely difficult to remove the assembly from the opto-electronic device without damaging the opto-electronic device. By having an easily removable adaptor it is possible to re-use circuit boards with different optical connectors or to replace an adaptor in the event that its performance is not satisfactory.

An additional advantage of the interface adaptor according to the present invention is that the opto-electronic device is held much more securely when compared with known techniques. Typically, in known techniques, the opto-electronic device will be secured within an assembly by two spot welds. In the present invention, the opto-electronic device is held in position by two sets of a locating means (preferably four locating means) that act on the opto-electronic device at two different locations. The fact that the device is held at two different locations makes the device less likely

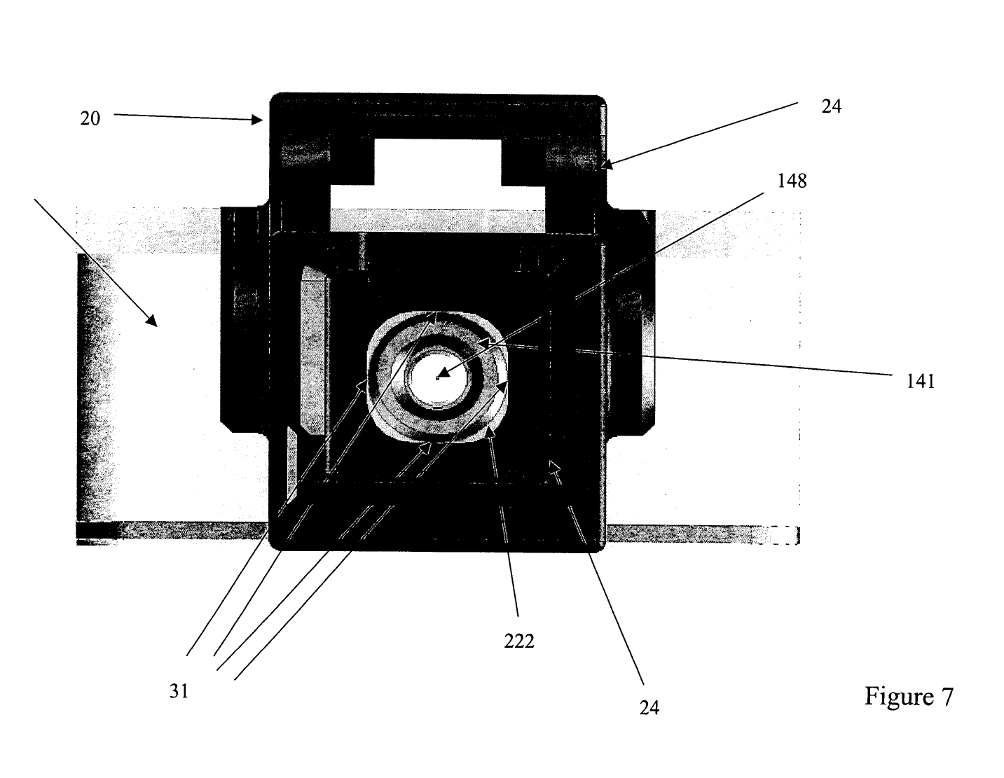

FIG. 7 shows a schematic depiction of an interface adaptor 20 according to the present invention, with an opto-electronic device 14 coupled to the device interface 22. FIG. 7 shows the interface adaptor 20 and the opto-electronic device 14 from the front of the interface adaptor and the connector interface 24. The cylindrical region 141 of the opto-electronic device 14 can be seen received within the internal aperture 222 of the device interface. It can be seen that the internal aperture comprises four concentric locating means 31 that serve to hold the opto-electronic device in the desired position relative to an optical connector. The optical region 148 of the opto-electronic device 14 is held in position such that when an optical connector is inserted into the connector interface 24, the connector and the optical region are in optical communication.

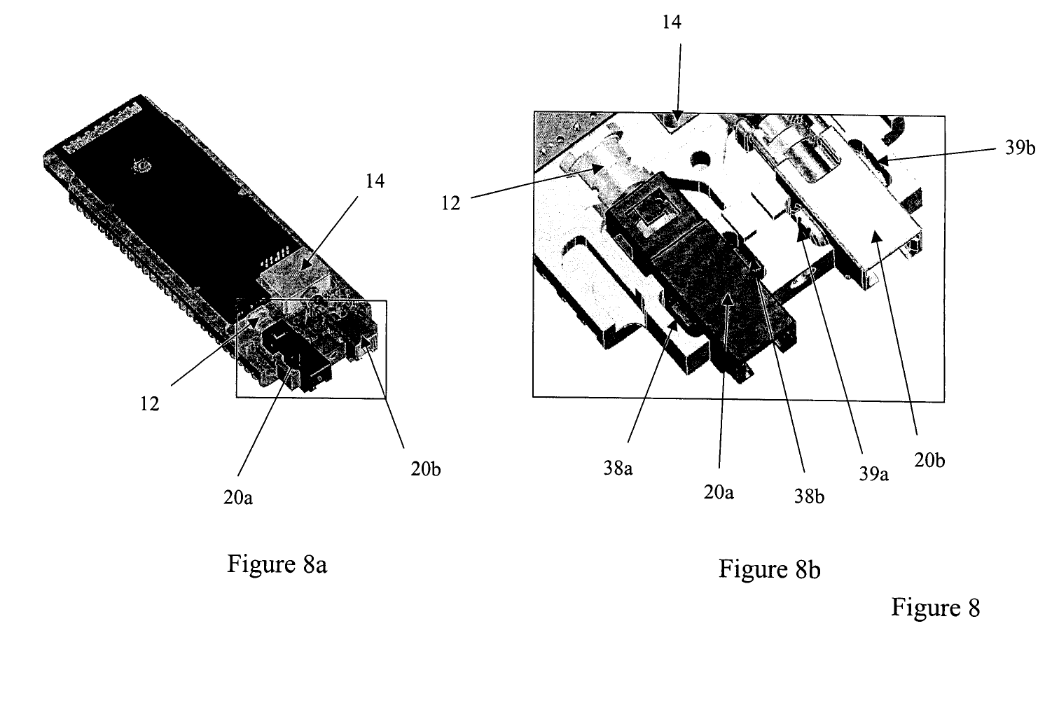

FIG. 8a shows a schematic depiction of a circuit board 10 comprising optical transmitter 12 and optical receiver 14, which are connected respectively to interface adaptors 20a and 20b. FIG. 8b is a detailed view of the portion of FIG. 8a shown in the box B. Interface adaptor 20a is secured to the circuit board 10 by adhesive potting 38a and 38b, and interface adaptor 20b is secured to the circuit board by adhesive potting 39a and 39b.

The interface adaptor may be conveniently manufactured using plastic injection moulding techniques and conventional amorphous polymers. A preferred material is a polyetherimide (PEI) resin (which is sold by General Electrics under the trade mark Ultem®) as it is able to maintain exceptional strength and unaffected modulus at high temperatures. (up to 200° C., T_{g} of 217° C.). Furthermore, this material may be electroplated, in order to provide EMI shielding for the interface adaptor, has a good resistance to a broad range of chemicals and has inherent flame retardancy properties. The combination of material and process means that it should be possible to produce interface adaptors for approximately $1, replacing a previously expensive component ($100+) with one that is effectively disposable. It has been found that the material can be used with the preferred manufacturing technique to control the dimensions of the interface adaptor with an accuracy of ±0.025 mm. It will be readily understood that other materials, for example mouldable metals, and manufacturing processes may be used if they can provide similar dimensional control and material properties.

The foregoing disclosure includes the best mode devised by the inventor for practicing the invention. It is apparent, however, that several variations in the present invention may be conceivable by one skilled in the art. Inasmuch as the foregoing disclosure is intended to enable one skilled in the pertinent art to practice the instant invention, it should not be construed to be limited thereby, but should be construed to include such aforementioned variations.

1. An interface adaptor for an opto-electronic device, the interface adaptor comprising:
a first portion for receiving an optical connector;
a second portion for receiving an opto-electronic device; and
a third portion for connecting said first portion to said second portion, wherein the second portion comprises
(a) a first aperture to receive said opto-electronic device within said second portion of said interface adaptor; and
(b) a second aperture to receive said opto-electronic device, said first and second apertures comprising one or more projections located at the periphery of said apertures.

2. An interface adaptor as in claim 1, wherein said second portion further comprises one or more retaining means to resist the removal of an opto-electronic device from said interface adaptor.

3. An interface adaptor as in claim 1, wherein said first and second apertures of said second portion comprise three or more projections located at the periphery of said apertures.

4. An interface adaptor as in claim 1, wherein said second portion further comprises engagement means such that an opto-electronic device can be secured relative to said interface adaptor by engaging an opto-electronic device and said engagement means with a securing device.

5. An interface adaptor as in claim 1, wherein said interface adaptor is formed from a plastics material.

6. An interface adaptor as in claim 1, wherein said interface adaptor is formed from a metallic material.

7. An interface adaptor as in claim 5, wherein one or more regions of said interface adaptor are selectively coated.

8. An interface adaptor as in claim 7, wherein one or more regions of said interface adaptor are selectively coated with an insulative material.

9. An interface adaptor as in claim 7, wherein one or more regions of said interface adaptor are selectively coated with a conductive material.
